(19) United States
(12) Patent Application Publication
(10) Pub. No.: US 2002/0121781 A1
(43) Pub. Date: Sep. 5, 2002

(54) Wind-driven powder generator

(76) Inventor: Patrick Joseph Douglas, Castletown (GB)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/048,602

(22) PCT Filed: May 31, 2001
(86) PCT No.: PCT/GB01/02411

(30) Foreign Application Priority Data
Jun. 1, 2000 (GB) 0013191.2
Nov. 22, 2000 (GB) 0028389.5

(51) Int. Cl. F03D 9/00; H02P 9/04

(52) U.S. Cl. 290/55

(57) ABSTRACT

This disclosure is concerned with the generation of power by a wind-driven power generator, in which the generator is transported from a public highway to a required site on a tracked vehicle having a loading platform on which the generator is loaded, and then is erected on site to convert prevailing wind into mechanical power, and electrical power.

This invention relates generally to the generation of power by a wind-driven power generator.

Increasing attention is being given, in both developed countries, and under developed countries, to the generation of power from so-called renewable energy sources e.g. wave power and wind power. To date, most efforts have been concentrated on the direct generation of electricity from wind power, and so-called “wind farms” are being installed, which comprise large air-driven propeller devices arranged on sites which are normally exposed to substantial wind forces e.g. on the tops of hills and in the path of prevailing winds, or on coastal sites. The propeller blades apply rotary mechanical power input to an electrical generator, and which may transmit electricity to a local user, or may feed electricity into a national electrical grid. The selection of suitable sites for a wind driven power generator usually results in a difficult and expensive installation, since there is not normally easy access to the site from the public highway. Given the very large size of current designs of wind driven generators, the transportation and assembly on site is an expensive exercise and which may involve, for example, the laying of a roadway from the nearest access point on a public highway and across quite often rough terrain, and also the laying of suitable “hard standing” so that assembly can take place on site. Therefore, although the energy input source (wind) is freely available, the capital cost of manufacture, and installation at a remote site, can be a substantial sum, and which has to be written off over the expected useful life of the generator.

There is therefore a need to provide a less expensive means of delivering a wind driven generator to a site, and it is an object of one aspect of the invention to seek to meet this need.

There is also a further need to provide an alternative type of output power from a wind driven device (an alternative to the electricity), and it is an object of another aspect of the invention to seek to meet this further need.

According to a first aspect of the invention there is provided a method of installing a wind driven power generator on site, and which comprises transporting the generator from a highway to the site on a tracked vehicle having a loading platform on which the generator is loaded, unloading the generator at the site, and then erecting the generator on the site.

A small tracked vehicle may be utilised, and which may be suitably adapted to mount the generator thereon, and such a vehicle is sufficiently manoeuvrable to allow the generator to be transported from a public or other highway and over rough terrain to the site.

In an alternative development, according to a second aspect of the invention, the generator may be permanently or semi-permanently installed on the loading platform, in an erected mode ready for use, and which can then be transported to a suitable site, and manoeuvred as necessary to take best advantage of the wind available.

The generator may generate electrical power by direct mechanical input to an electrical generator, and which may transmit electricity to a local user, or to a grid network. The prime mover to operate the tracked vehicle may also be utilised as a source of back-up mechanical power, in the event of insufficient wind power being available. Means may be provided to cause automatic operation of the prime mover when the wind power falls below a predetermined level.

According to a third aspect of the invention there is provided a wind driven power generator which comprises:

a mast;

a propeller device rotatably mounted on the mast;

a fluid-pressuring device arranged to receive mechanical input power from the propeller device, and to apply pressure to a fluid pressure circuit; and,

a fluid-pressure driven device coupled with said circuit and arranged to provide a mechanical power output.

The fluid pressure circuit may be a gas circuit, although the presently preferred fluid medium is hydraulic fluid, in which case the fluid pressurising device may be a hydraulic pump, and the driven device may comprise a hydraulic motor.

The mast, and/or the propellor device may be capable of being rotatably adjusted so as to face the prevailing wind.

The power generator of the third aspect of the invention may be used to supply input power to a local energy consumer e.g. an operator of mechanical plant, such as a stone crushing and / or screening installation.

In a development of the generator of the third aspect of the invention, the fluid-pressure driven device can be replaced by a restriction in a fluid circuit, and arranged to convert pressure energy into heat, and then to transfer the heat generated to any suitable heat consumer e.g. a domestic or other heating installation.

It is envisaged that, with selection of appropriate parameters, pressure drops of up to 4,000 psi can be achieved, with resulting generation of substantial quantities of heat.

Optionally, the features of the second and third aspects of the invention may be combined, so that wind power may be used when available, but which can switch automatically to back-up power from the prime mover of the tracked vehicle when necessary.

Preferred embodiments of the invention will now be described in detail, by way of example only, with reference to the accompanying drawings, in which:

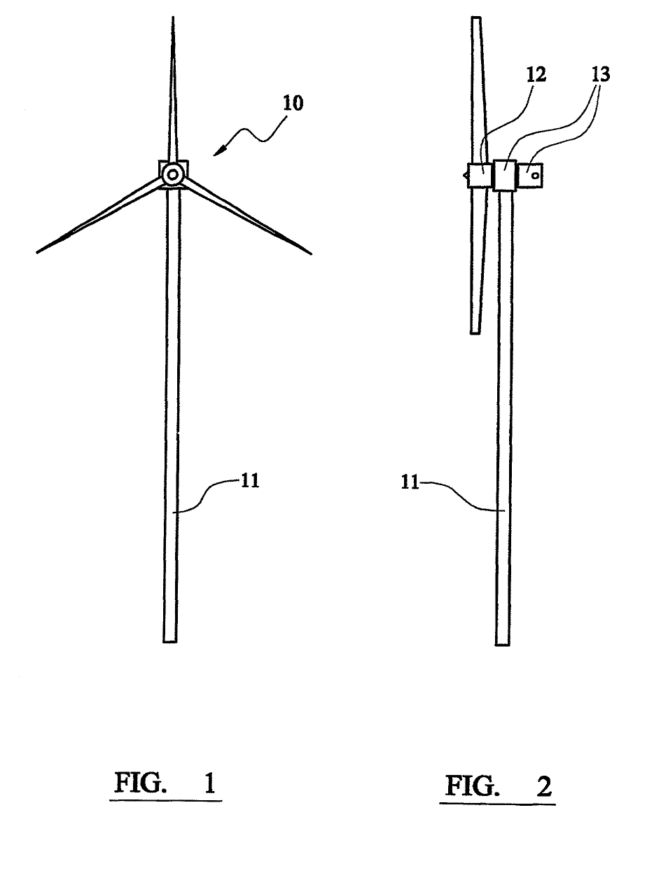

FIG. 1 is a front view of a wind driven power generator according to the invention;

FIG. 2 is a side view of the generator shown in FIG. 1;

FIG. 3 is a front view of the wind driven power generator mounted (permanently or demountably for subsequent installation on site) on a loading platform of a tracked vehicle; and,

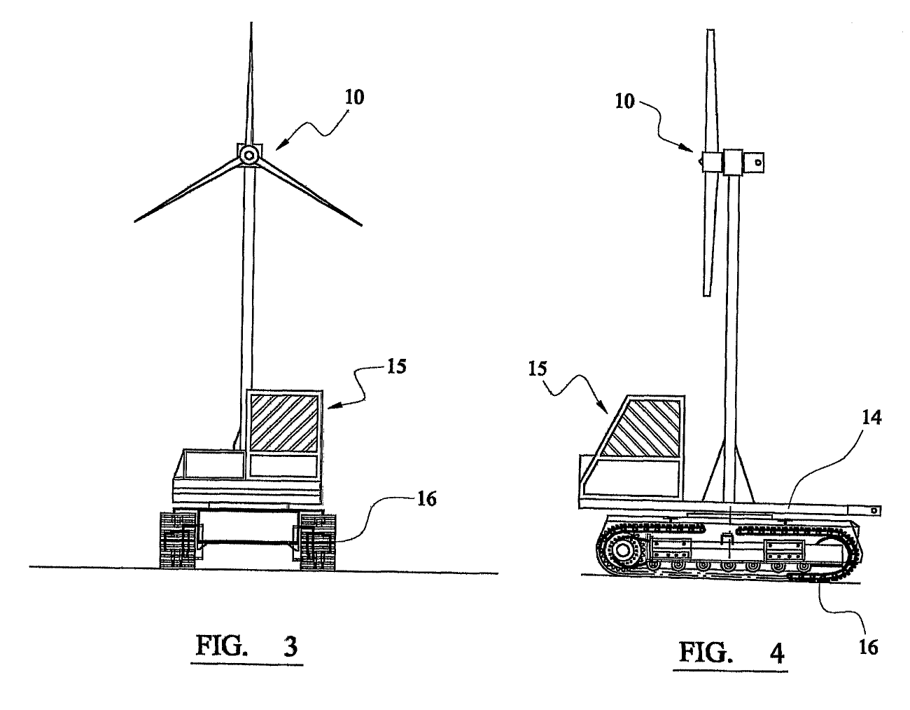

FIG. 4 is a side view of the tracked vehicle with the generator loaded or mounted thereon.

The illustrated embodiment of wind driven power generator can be installed on site by transporting the generator from a highway to the site on a tracked vehicle having a loading platform on which the generator is unloaded, followed by unloading of the generator at the site, and then finally by erecting the generator on the site.

The tracked vehicle utilised is suitably adapted to mount the generator thereon, and which is sufficiently manoeuvrable to allow the generator to be transported from a public or other highway over rough terrain to the site.

The generator may be permanently or semi-permanently installed on the loading platform, in an erected mode ready for use, and which can then be transported to a suitable site, and manoeuvred as necessary to take best advantage of the wind available.

The generator may generate electrical power by direct mechanical input to an electrical generator, and which may transmit electricity to a local user, or to a grid network. The prime mover to operate the tracked vehicle may also be utilised as a source of back-up mechanical power, in the event of insufficient wind power being available. Means may be provided to cause automatic operation of the prime mover when the wind power falls between a predetermined level.

Referring now to the drawings, a wind driven power generator is designated generally by reference 10, and comprises a mast 11, a propeller device 12 rotatably mounted on the mast 11, a fluid-pressurising device arranged to receive mechanical input power from the propeller device 12, and to apply pressure to a fluid pressure circuit, and a fluid-pressure driven device coupled with the circuit and arranged to provide a mechanical power output.

The pressurising device, and the driven device will be selected according to the type of fluid used in the gas circuit, although in the preferred arrangement the fluid medium is hydraulic fluid, in which case the fluid pressurising device is a hydraulic pump, and the driven device is a hydraulic motor.

FIGS. 1 and 2 illustrate schematically only, designated by reference 13, the means of converting mechanical input power from the propeller device 12 to a pressurised fluid circuit from which mechanical output power can be derived.

Referring now to FIGS. 3 and 4, this shows the generator 10 loaded on a loading platform 14 of a small tracked vehicle 15 having a set of endless crawler tracks 16 which allow the generator 10 to be transported over rough terrain from the public highway and to the installation site.

The generator 10 may be unloaded on site, and then subsequently erected in a required position on site. Alternatively, the generator 10 may be permanently, or semi-permanently mounted on the platform 14, in the erected mode ready for use, and then transported to a suitable site, and manoeuvred as necessary to take best advantage of the wind available.

The preferred power generated is mechanical output power derived from a pressurised fluid circuit. However, it is within the scope of this invention to use the mechanical input power derived from the propeller device 12 to generate electricity.

The prime mover provided to operated the tracked vehicle 15 may also be utilised as a source of back-up mechanical power, in the event of insufficient wind power being available.

1. A method of installing a wind driven power generator on site, and which comprises transporting the generator from a highway to the site on a tracked vehicle having a loading platform on which the generator is loaded, unloading the generator at the site, and then erecting the generator on the site.

2. A method according to claim 1, in which a small tracked vehicle is utilised, suitably adapted to mount the generator thereon, and being sufficiently manoeuvrable to allow the generator to be transported from a public or other highway and over rough terrain to the site.

3. A method of installing a wind driven power generator on site, and which comprises installing a generator permanently, or semi-permanently on a loading platform of a tracked vehicle, with the generator being installed in an erected mode ready for use, transporting the generator to a suitable site, and then manoeuvering the vehicle as necessary to take best advantage of the wind available.

4. A method according to any one of claims 1 to 3, in which the generator is arranged to generate electrical power by direct mechanical input to an electrical generator, and which can transmit electricity to a local user, or to a grid network.

5. A method according to claim 4, in which a prime mover provided to operate the tracked vehicle is also utilised as a source of back-up mechanical power, in the event of insufficient wind power being available.

6. A method according to claim 5, in which means is provided to cause automatic operation of the prime mover when the wind power falls below a predetermined level.

7. A wind driven power generator which comprises:
a mast;
a propeller device rotatably mounted on the mast;
a fluid-pressurising device arranged to receive mechanical input power from the propeller device, and to apply pressure to a fluid pressure circuit; and
a fluid-pressure driven device coupled with said circuit and arranged to provide a mechanical power output.

8. A generator according to claim 7, in which the fluid pressure circuit is a gas circuit.

9. A generator according to claim 7, in which the fluid pressure circuit is a hydraulic circuit, and the fluid pressurising device is a hydraulic pump, and the driven device is a hydraulic motor.

10. A generator according to any one of claims 7 to 9, in which the mast and/or the propeller device are capable of being rotatably adjusted so as to face the prevailing wind.

11. A generator according to claim 7, and arranged to supply input power to a local energy consumer e.g. an operator of mechanical plant, such as a stone crushing and/or screening installation.

12. A wind driven power generator which comprises:
a mast;
a propeller device rotatably mounted on the mast;
a fluid-pressuring device arranged to receive mechanical input power from the propeller device, and to apply pressure to a fluid pressure circuit, said device being formed by a restriction provided in the fluid circuit which is arranged to convert pressure energy into heat; and
means to transfer the heat generated to any suitable heat consumer e.g. a domestic or other heating installation.

13. A generator according to claim 12, in which, with selection of appropriate parameters, pressure drops of up to 4000 psi can be achieved, with resulting generation of substantial quantities of heat.
